(19) United States
(12) Patent Application Publication
(10) Pub. No.: US 2006/0116098 A1
(43) Pub. Date: Jun. 1, 2006

(54) Sound intermediate frequency conversion circuit

(76) Inventors: Yasuo Oba, Otsu-shi (JP); Makoto Ikuma, Nagaokakyo-shi (JP)

Correspondence Address: WENDEROTH, LIND & PONACK L.L.P., 2033 K. STREET, NW, SUITE 800, WASHINGTON, DC, 20006, US

(21) Appl. No.: 11/280,280

(22) Filed: Nov. 17, 2005

(30) Foreign Application Priority Data
Nov. 19, 2004 (JP) P2004-335787

(51) Int. Cl. H04B 1/26

(52) U.S. Cl. 455/313

(57) ABSTRACT

In a sound intermediate frequency conversion circuit, a second mixer receives an output of a first mixer which converts a first SIF; reference signal sources and receives an output of a frequency divider. The output of the reference signal source is got through the divider, and then a frequency conversion is performed by the second mixer so that the second SIF has a constant value. A frequency dividing ratio of the frequency divider is selected according to a frequency difference between a VIF and a first SIF. Thus, a conversion to a constant frequency is possible without deteriorating sound reception performance in a television receiver mounted in a mobile object.

### BACKGROUND OF THE INVENTION

1. Field of the Invention

The present invention relates to a sound intermediate frequency conversion circuit, and more particularly to a sound intermediate frequency conversion circuit which handles plural sound intermediate frequencies and constructs a sound receiver with emphasis on sound characteristics. Hereinafter, the terms “sound intermediate frequency” and “video intermediate frequency” are abbreviated as “SIF” and “VIF”, respectively.

2. Description of the Related Art

In a region where television broadcast waves using different frequencies and schemes can be received, a receiver capable of receiving all the television broadcast waves is sometimes needed. In this case, different radio frequencies (RF) are, of course, used, and also different video intermediate frequencies (VIF) and different first sound intermediate frequencies (the first SIF) are used. Besides, as for the second sound intermediate frequency (the second SIF) which is a difference between the VIF and the first SIF, there are three kinds of frequencies, i.e., 5.5 MHz, 6.0 MHz, 6.5 MHz in a PAL television broadcast system. Furthermore, the second SIF signal is set to 4.5 MHz in a NTSC television signal. In order to handle these plural second SIFs, there have hitherto been proposed various SIF signal processing techniques as disclosed in Japanese Patent Laid-Open No. 5-007352 and Japanese Patent Laid-Open No. 10-136287, for example.

However, in recent years, a television set has come to be mounted in a mobile receiver or a mobile object such as a car, and thus the conventional techniques may be insufficient. Since videos cannot be viewed during driving under regulations, an in-vehicle television set must have higher sound performance compared to a conventional home television set. Specifically, a television receiver having excellent sound sensitivity and noise prevention characteristics is needed, and miniaturization is also required.

A conventional SIF conversion circuit for use in a car handling plural kinds of second SIFs will be described below with reference to FIG. 6.

FIG. 6 is a block diagram showing a schematic configuration of a conventional split-carrier television receiver for use in a car. The television receiver includes an antenna 1, a television tuner 2, a video band pass filter (BPF1) 3, a video intermediate frequency signal (VIF) processing section 4, a second sound intermediate frequency signal (SIF) processing section 6, a first sound intermediate frequency band pass filter (BPF2) 8, a second sound intermediate frequency band pass filter (BPF3) 9, and an SIF conversion circuit 100. Reference numeral 5 denotes a video baseband output terminal, and 7 denotes a sound baseband output terminal.

The SIF conversion circuit 100 includes a mixer (MIX1) 10, a buffer amphfier (BUF) 13, a crystal oscillator (OSC) 14, and crystal oscillators 15a, 15b and 15c. Reference numeral 20 denotes a crystal oscillator selection terminal for switching thereof.

The operation of the conventional television receiver having the configuration described above will now be described. Referring to FIG. 6, a television RF signal received by the antenna 1 is selected, amplified and converted to a VIF signal and a first SIF signal (also referred to below as “SIF1 signal”) by the TV tuner 2. Fundamentally the VIF and the first SIF signal vary depending on broadcast regions. However, when a TV tuner section based on a synthesizer system is used, the VIF can be made constant by setting a local oscillator (VCO) frequency of the tuner section to an appropriate value. In this case, the first SIF varies depending on regions.

Subsequently, the VIF signal is got through the band pass filter 3, and supplied to the video intermediate frequency signal (VIF) processing section 4 where the supplied VIF signal is amplified, detected and outputted as a video baseband signal from the terminal 5. On the other hand, the first SIF signal is got through the band pass filter 8 and supplied to the SIF conversion circuit 100. In the SIF conversion circuit 100, a frequency conversion is performed so that the frequency of a second SIF signal is constant. The output from the SIF conversion circuit 100 is got through the band pass filter 9, and supplied to the SIF processing section 6 to be amplified, detected and then the resultant signal is outputted as a sound baseband signal from the terminal 7.

The operation of the SIF conversion circuit 100 will now be described. After got through the band pass filter 8, the first SIF signal is supplied to the mixer (MIX1) 10, and mixed with an output signal of the crystal oscillator 14 to be converted to a second SIF signal (also referred to below as “SIF2 signal”). Herein, a suitable one is selected among the crystal oscillators 15a, 15b and 15c according to the first SIF signal being used, so that the frequency of the second SIF signal is made constant. For example, when the tuner section 2 is set to have the frequency of the VIF signal being constant at 38.0 MHz, the frequency of the first SIF signal is 32.5 MHz, 32.0 MHz or 31.5 MHz, corresponding to 5.5 MHz, 6.0 MHz or 6.5 MHz each being a difference value between the VIF and the first SIF. Herein, if the crystal oscillators 15a, 15b or 15c is selected so that the oscillation frequency of the crystal oscillator 14 is 21.8 MHz, 21.3 MHZ, or 20.8 MHz, the resultant frequency of the second SIF signal is always constant at 10.7 MHz.

In this example, the second SIF signal has a constant frequency of 10.7 MHz, which corresponds to the difference between the FM and the intermediate frequency in the FM receiver. However, the second SIF signal may have another frequency. In this construction, a crystal oscillator shown by a block 14 in FIG. 6 is used to obtain an oscillation output with satisfactory phase noise characteristics. Also, when NTSC reception is taken into account, if an additional crystal oscillator of 22.8 MHz is provided, reception becomes possible even when the difference between the VIF and first SIF is 4.5 MHz.

In the television receiver shown in FIG. 6, an FM broadcast wave of a sound broadcast can be also received. Similarly to a television sound broadcast, FM broadcast uses an FM modulation wave of which frequency exists in a VHF band, so it is possible to receive an FM broadcast wave by using the sound demodulation part of FIG. 6. Specifically, an FM broadcast wave is received by the TV tuner section 2; and if the first SIF is, for example, 32.0 MHz and the frequency of the crystal oscillator is 21.3 MHz, then the second SIF of 10.7 MHz is obtained, so that the FM sound reception is possible. In this case, since there is no video signal, the operation of the video intermediate frequency signal (VIF) processing section 4 is stopped.

However, the conventional SIF conversion circuit having the configuration shown in FIG. 6 requires three or four crystal oscillators, thus costing much. Also, since the installation space is large, it is not suitable to be applied to a mobile receiver in which miniaturization is required.

Also, the technique disclosed in Japanese Patent Laid-Open No. 5-007352 can only handle three kinds of waves when the differences between the video intermediate frequency (VIF) and the sound intermediate frequency (SIF) are 5.5 MHz, 6.0 MHz and 6.5 MHz, and cannot handle an NTSC wave of 4.5 MHz.

The technique disclosed in Japanese Patent Laid-Open No. 10-136287 can handle an NTSC wave of the above frequency, but requires a large space for constructing a PLL circuit. Furthermore, the use of an IC-incorporated type local oscillator (VCO) leads to unsatisfactory noise characteristics, causing deterioration of sound characteristics.

To solve the above problem, an object of the present invention is to provide an SIF conversion circuit which can handle the case in which the frequency differences between the video and the sound intermediate frequencies (i.e., VIF-SIF) are 4.5 MHz, 5.5 MHz, 6.0 MHz, and 6.5 MHz taking NTSC into consideration, allowing miniaturization in size, and preventing, in particular, sound reception performance from being deteriorated in a mobile sound receiver such as an in-vehicle receiver.

### SUMMARY OF THE INVENTION

In order to achieve the above object, a sound intermediate frequency conversion circuit according to a first aspect of the present invention converts a frequency of a first sound intermediate frequency signal to obtain a second sound intermediate frequency signal having a constant frequency. The sound intermediate frequency conversion circuit comprises: a first oscillator which outputs an oscillation signal; a first mixer which receives the first sound intermediate frequency signal and the oscillation signal to be mixed with each other, and outputs a resultant mixed signal; a filter which selectively passes a signal having a desired frequency among the output signals of the first mixer; a second oscillator which outputs a reference oscillation signal; a frequency divider which divides the frequency of the reference oscillation signal; and a second mixer which mixes the output signal of the filter and the output signal of the frequency divider, and outputs the second sound intermediate frequency signal.

According to this configuration, the reference oscillation signal is divided by the frequency divider having a simple configuration, and mixed with the output of the first mixer to obtain a single frequency of the second SIF. Thus, an SIF conversion circuit having a small size and satisfactory noise characteristics can be implemented.

In the configuration of the first aspect, a reference signal oscillator of a television tuner section may preferably be used as the second oscillator of the SIF conversion circuit. According to this configuration, the number of oscillators can be reduced by one and the reference signal oscillator having satisfactory noise characteristics can be used, and therefore an SIF conversion circuit having a small size and low noise can be constructed.

A sound intermediate frequency conversion circuit according to a second aspect of the present invention converts a frequency of a first sound intermediate frequency signal to obtain a second sound intermediate frequency signal having a constant frequency. The sound intermediate frequency conversion circuit comprises: a reference signal oscillator which generates a reference oscillation signal; a first mixer which receives the first sound intermediate frequency signal and the reference oscillation signal to be mixed with each other, and outputs a resultant mixed signal; a filter which selectively passes a signal having a desired frequency among the output signals of the first mixer; a frequency divider which divides the frequency of the reference oscillation signal; and a second mixer which mixes the output signal of the filter and the output signal of the frequency divider, and outputs the second sound intermediate frequency signal.

According to this configuration, the reference oscillation signal is divided by the frequency divider having a simple configuration, and mixed with the output of the first mixer to obtain a single frequency of the second SIF. Thus, an SIF conversion circuit having a small size and satisfactory noise characteristics can be implemented.

In the configuration according to the first or second aspect of the present invention, the frequency divider preferably may include a switching means for dividing the frequency of the reference oscillation signal and selecting a desired frequency as a frequency of the output signal of the frequency divider according to the frequency of the first sound intermediate frequency signal.

According to this configuration, a frequency divider capable of outputting, for example, a frequency of 0.5 MHz or 1.0 MHz, can be constructed with a small-scale circuit configuration, and thus an SIF conversion circuit with miniaturization in size can be implemented.

Also, in the configuration according to the second aspect of the present invention, the reference signal oscillator may preferably be a crystal oscillator. According to this configuration, by using a crystal oscillator having satisfactory noise characteristics as the reference signal oscillator, an SIF conversion circuit having low noise can be constructed.

Also, in the configuration according to the second aspect of the present invention, the frequency divider may stop the operation thereof when the second mixer does not perform a frequency conversion operation. According to this configuration, it is possible to construct an SIF conversion circuit in which deterioration of noise characteristics, occurring in the frequency divider, due to harmonic components of the reference signal can be minimized.

A sound receiver according to a third aspect of the present invention includes the sound intermediate frequency conversion circuit set forth in the first or second aspect described above, which converts a first sound intermediate frequency to a second sound intermediate frequency. The sound receiver further includes: an antenna which receives an RF signal; a tuner section which receives the RF signal, converts the RF signal to a first sound intermediate frequency signal, and outputs the first sound intermediate frequency signal; a further filter which selectively allows passage of the first sound intermediate frequency signal; and a sound intermediate frequency processing section which outputs a sound baseband signal based on the second sound intermediate frequency.

According to the first aspect of the present invention, the SIF conversion circuit is provided with a mixer, oscillator and frequency divider in addition to a conventional SIF conversion circuit, and selection of a desired frequency is performed among the frequencies obtained by the oscillator or the frequency divider. Thus, a television receiver which handles plural values of the difference between the video intermediate frequency and the sound intermediate frequency, can be constructed without deteriorating sound characteristics, thus making it possible to construct a television receiver most suitable for use in a mobile object such as a car.

In the SIF conversion circuit according to the first aspect of the present invention, the reference signal oscillator of the tuner section is preferably used as the second oscillator. Thus, the number of oscillators can be reduced by one, which makes it possible to construct an SIF conversion circuit with miniaturization in size.

The SIF conversion circuit according to the second aspect of the present invention is provided with a mixer and a frequency divider with the frequency dividing ratio thereof selectable, in addition to a conventional SIF conversion circuit, and a selection of a desired frequency is performed among the frequencies obtained by dividing the output of the oscillator. Thus, a television receiver which handles plural values of the difference between the video intermediate frequency and the sound intermediate frequency, can be constructed without deteriorating sound characteristics, which makes it possible to construct a television receiver most suitable for use in a mobile object such as a car.

In the SIF conversion circuit according to the first or second aspect of the present invention, the output of the frequency divider is preferably switched according to the frequency of the first SIF signal, whereby an SIF conversion circuit with a small number of elements can be constructed, and miniaturization is thus possible.

In the SIF conversion circuit according to the second aspect of the present invention, the oscillator is preferably a crystal oscillator, whereby an SIF conversion circuit having satisfactory noise characteristics can be constructed.

In the SIF conversion circuit according to the second aspect of the present invention, the operation of the frequency divider preferably is stopped when the mixer does not perform any frequency conversion operation, whereby an SIF conversion circuit with little disturbance can be constructed.

The sound receiver according to a third aspect of the present invention includes the sound intermediate frequency conversion circuit set forth in the first or second aspect described above, which converts a first sound intermediate frequency to a second sound intermediate frequency. The sound receiver further includes: the antenna which receives an RF signal; the tuner section which receives the RF signal, converts the RF signal to a first sound intermediate frequency signal, and outputs the first sound intermediate frequency signal. The sound receiver further includes the filter which selectively allows passage of the first sound intermediate frequency signal; and the sound intermediate frequency processing section which outputs a sound baseband signal based on the second sound intermediate frequency. Thus, an excellent sound receiver having a small size and good sound quality can be constructed.

### BRIEF DESCRIPTION OF THE DRAWINGS

FIG. 1 is a block diagram of a television receiver including an SIF conversion circuit according to Embodiment 1 of the present invention;

FIG. 2 is a block diagram showing a modified example of Embodiment 1 of the present invention;

FIG. 3 is a block diagram of a television receiver including an SIF conversion circuit according to Embodiment 2 of the present invention;

FIG. 4 is a block diagram showing a configuration of a frequency divider circuit for use in a frequency conversion circuit according to the present invention;

FIG. 5 is a block diagram showing a circuit configuration of a mixer for use in the frequency conversion circuit according to the present invention; and

FIG. 6 is a block diagram of a television receiver including a conventional SIF conversion circuit.

### DESCRIPTION OF THE PREFERRED EMBODIMENTS

Embodiments of the present invention will be described below with reference to the accompanying drawings. The same reference numerals are applied to like parts in each drawing, and hence repeated explanation thereof is omitted for simplification.

### Embodiment 1

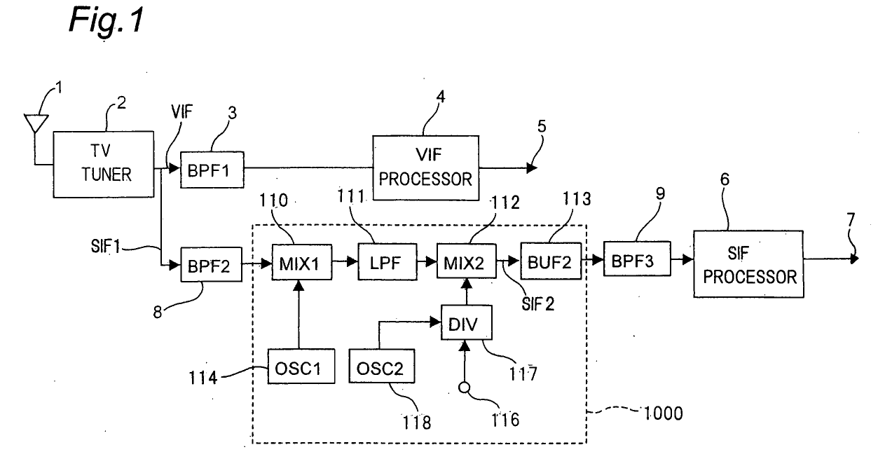

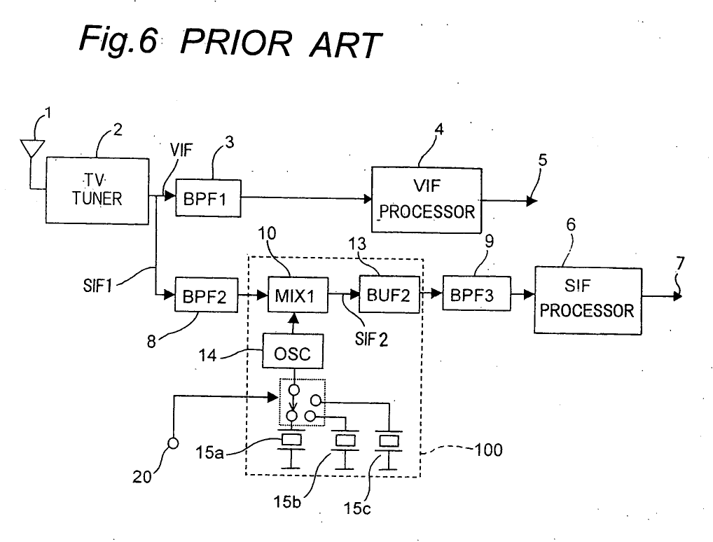

FIG. 1 is a block diagram of a television receiver including an SIF conversion circuit according to Embodiment 1, in which the same reference numerals are applied to parts corresponding to a conventional example shown in FIG. 6. This television receiver includes an antenna 1, a television tuner 2, a video band pass filter (BPF1) 3, a video intermediate frequency signal (VIF) processing section 4, a sound intermediate frequency signal (SIF) processing section 6, a first sound intermediate frequency band pass filter (BPF2) 8, a second sound intermediate frequency band pass filter (BPF3) 9, and an SIF conversion circuit 1000. Reference numeral 5 denotes a video baseband output terminal, and 7 denotes a sound baseband output terminal.

The SIF conversion circuit 1000 includes a first mixer (MIX1) 110, a low pass filter (LPF) 111, a second mixer (MIX2) 112, a buffer amplifier (BUF2) 113, a first oscillator (OSC1) 114, a frequency divider 117, and a second oscillator (OSC2) 118. Reference numeral 116 denotes a switching terminal for selecting a frequency dividing ratio.

The operation of the television receiver including the SIF conversion circuit 1000 according to the present invention will now be described. Referring to FIG. 1, a television RF signal supplied through the antenna 1 is selected, amplified and converted to a VIF signal and a first SIF (SIF1) signal by the TV tuner 2. The VIF signal is passed through the band pass filter (BPF1) 3, and supplied to the video intermediate frequency signal (VIF) processing section 4 so that the supplied signal is amplified and detected, and then the resultant signal is outputted as a video baseband signal from the terminal 5.

On the other hand, the first SIF signal is passed through the band pass filter (BPF2) 8 and supplied to the SIF conversion circuit 1000. In the SIF conversion circuit 1000, the supplied first SIF signal is converted in frequency so that a second SIF (SIF 2) signal having a constant frequency is obtained. The output signal from the SIF conversion circuit 1000 is passed through the band pass filter (BPF3) 9, and supplied to the sound intermediate frequency signal (SIF) processing section 6. Thus, the supplied signal is amplified and detected, and then the resultant signal is outputted as a sound baseband signal from the terminal 7.

The operation of the SIF conversion circuit 1000 will now be described. After got through the band pass filter (BPF2) 8, the first SIF signal is supplied to the first mixer (MIX1) 110 and mixed with the output of the first oscillator 114 and then supplied to the low pass filter 111. In the low pass filter 111, only signals having a low frequency among the output signals of the first mixer (MIX1) 110 are passed to the second mixer (MIX2) 112. Meanwhile, the output signal of the second oscillator 118 is supplied to the frequency divider 117. The output frequency of the frequency divider 117 is selected by a switching signal supplied from the terminal 116 for selecting the frequency dividing ratio. The frequency dividing ratio is selected according to a difference between the video intermediate frequency (VIF) and the sound intermediate frequency SIF. The output signal of the frequency divider 117 is supplied to the second mixer (MIX2) 112 and mixed with the output signal of the low pass filter 111, whereby a frequency conversion is performed so that the output signal (SIF2) of the second mixer (MIX2) 112 has a constant frequency.

In this configuration, the second mixer (MIX2) 112 receives an oscillator output signal via the frequency divider 117 as well as the output signal of the low pass filter 111, and then the supplied two signals are mixed by the second mixer (MIX2) 112 to generate a SIF2 signal having frequency components corresponding to a sum and a difference of the two signals.

For example, if the video intermediate frequency (VIF) is set to 38.0 MHz as described above and the output frequency of the first oscillator 114 is 26.0 MHz, then frequency difference values 5.5 MHz, 6.0 MHz, 6.5 MHz and 7.5 MHz are obtained as the output frequency of the first mixer 110 by calculating the difference values of (SIF1-26.0 MHz), respectively corresponding to difference values 6.5 MHz. 6.0 MHz, 5.5 MHz and 4.5 MHz between the frequency of the VIF signal and the frequency of the first SIF signal. The frequency thus obtained is supplied to the second mixer 112; and if the output of the frequency divider 117 is 1.0 MHz, 0.5 MHz, 0 MHz (no output) or 1.0 MHz corresponding to the above calculated first SIFs, then the output of the second mixer 112 has a constant frequency component of 6.5 MHz. The relationship of these frequencies is shown in Table 1. It is noted that frequencies in parentheses shown in Table 1 are generated by each mixer but shut out by the filter at the rear stage.

The output (SIF2) of the second mixer (MIX2) 112 is supplied to the buffer amplifier 113 and then outputted from the SIF conversion circuit 1000. The output of the SIF conversion circuit 1000 is passed through the band pass filter 9 at the rear stage to allow passage of a desired frequency band, whereby a second SIF signal having a single frequency is obtained. The second SIF signal obtained through the band pass filter 9 is amplified and detected by the sound intermediate frequency signal (SIF) processing section 6 to obtain a sound baseband signal.

In the case where an FM broadcast wave is received, by setting the frequency of the first SIF signal to, for example, 31.5 MHz, and setting the output of the frequency divider 117 to 1.0 MHz, the FM broadcast wave can be received. In this case, no video signal is supplied to the video intermediate frequency signal (VIF) processing section 4, and therefore the processing section 4 is in a halting state so as not to generate noises.

The low pass filter 111 has a function of allowing passage of signals having a low frequency among the output signals of the first mixer 110. However, a band pass filter having such a low frequency band can also be used. The buffer amplifier 113 is used to achieve impedance matching with the band pass filter 9 at the next stage, and generally also serves as an amplifier having an amplification degree.

[Modification]

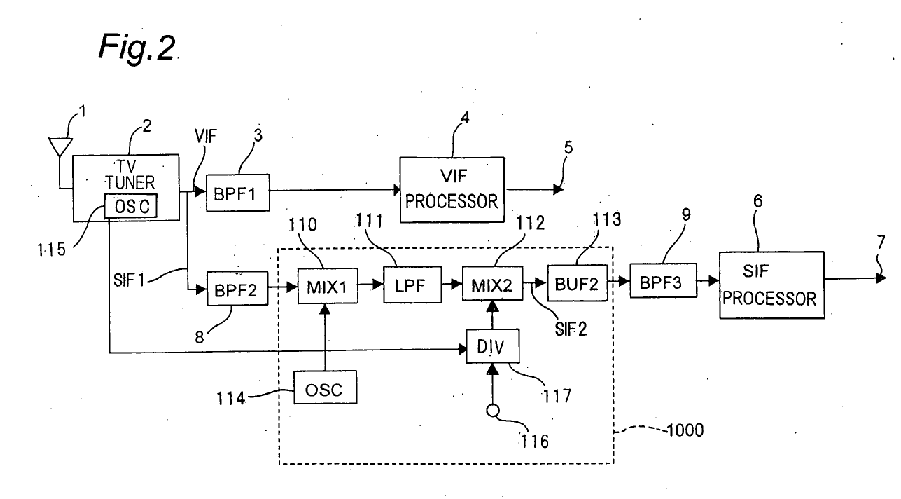

A modified example of the SIF conversion circuit according to the present embodiment 1 will now be described with reference to FIG. 2. In the construction shown in FIG. 1, the television tuner section 2 typically includes a reference signal oscillator (although not shown in FIG. 1) for generating a reference oscillation signal of 4.0 MHz. In view of this fact, as shown in FIG. 2, a reference signal oscillator 115 for generating a reference oscillation signal of 4.0 MHz included in the television tuner section 2 can also be used instead of using the second oscillator 118 of FIG. 1. Thus, the number of the used oscillators can be reduced by one, so that the size of the sound receiver can be further reduced. Also, the output of the reference signal oscillator is used as a reference frequency of PLL for channel selection, and a stable oscillation output is obtainable. Thus, with the reference signal oscillator, the SIF conversion circuit having excellent noise proof characteristics can be constructed.

### Embodiment 2

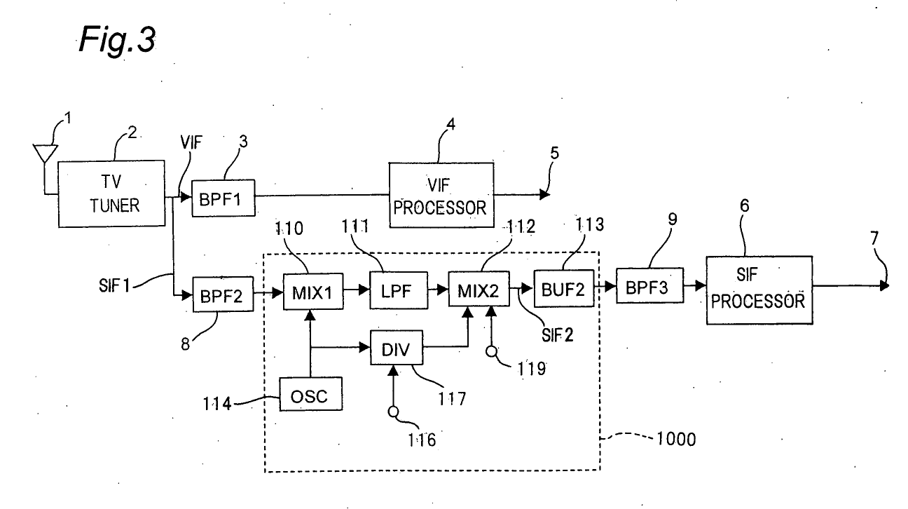

FIG. 3 is a block diagram of a television receiver including an SIF conversion circuit according to Embodiment 2, in which the same reference numerals are applied to like parts of Embodiment 1 shown in FIG. 1. This television receiver includes an antenna 1, a television tuner 2, a video band pass filter (BPF1) 3, a video intermediate frequency signal (VIF) processing section 4, a sound intermediate frequency signal (SIF) processing section 6, a first sound intermediate frequency band pass filter (BPF2) 8, a second sound intermediate frequency band pass filter (BPF3) 9, and an SIF conversion circuit 1000. Reference numeral 5 denotes a video baseband output terminal, and 7 denotes a sound baseband output terminal.

The SIF conversion circuit 1000 includes a first mixer (MIX1) 110, a low pass filter (LPF) 111, a second mixer (MIX2) 112, a buffer amplifier (BUF2) 113, an oscillator (OSC) 114, and a frequency divider (DIV) 117. Reference numeral 119 denotes an input terminal of a control signal for stopping the operation of the second mixer (MIX2) 112, and 116 denotes a switching terminal for selecting a frequency dividing ratio. The oscillator (OSC) 114 is a reference signal oscillator for generating a reference oscillation signal, for example.

The operation of the television receiver including the SIF conversion circuit according to Embodiment 2 will now be described. Referring to FIG. 3, a television RF signal supplied through the antenna 1 is selected, amplified and converted to a VIF signal and a first SIF signal by the TV tuner 2. The VIF signal is supplied to the band pass filter 3, and passed to the video intermediate frequency signal (VIF) processing section 4, so that the supplied signal is amplified and detected. Then, the resultant signal is outputted as a video baseband signal from the terminal 5.

On the other hand, the first SIF signal is supplied to the band pass filter 8 and passed to the SIF conversion circuit 1000. In the SIF conversion circuit 1000, a frequency conversion of the first SIF signal is performed so that the second SIF signal has a constant frequency. The output signal from the SIF conversion circuit 1000 is supplied to the band pass filter 9 and passed to the sound intermediate frequency signal (SIF) processing section 6, so that the supplied second SIF signal is amplified and detected. Then, the resultant signal is outputted as a sound baseband signal from the terminal 7.

The operation of the SIF conversion circuit 1000 according to the present embodiment 2 will now be described. After got through the band pass filter 8, the first SIF signal is supplied to the first mixer 110 and mixed with the output signal of the oscillator 114. The output signal of the first mixer 110 is supplied to the low pass filter 111, so that only signals having a low frequency among the output signals of the first mixer 110 are passed to the second mixer 112. Meanwhile, the output signal of the oscillator 114 is also supplied to the frequency divider 117. The frequency of the output signal of the frequency divider 117 is selected by a selection signal supplied from the terminal 116. The frequency dividing ratio is selected according to a difference between the video intermediate frequency (VIF) and the sound intermediate frequency SIF. The output signal of the frequency divider 117 is supplied to the second mixer 112, whereby a frequency conversion is performed so that the output (SIF2) signal of the second mixer 112 has a constant frequency.

Specifically, for example, if the video intermediate frequency (VIF) is set to 38.0 MHz as described above and the output frequency of the oscillator 114 is set to 26.0 MHz, then the frequency of the output signal of the first mixer 110 is obtained as 5.5 MHz, 6.0 MHz, 6.5 MHz or 7.5 MHz by the calculation of (SIF1-26.0 MHz), respectively corresponding to a difference value 6.5 MHz. 6.0 MHz, 5.5 MHz or 4.5 MHz between the frequency of the VIF signal and the frequency of the first SIF signal. The frequency thus obtained is supplied to the second mixer 112 via the low pass filter 111. If the output frequency of the frequency divider 117 is 1.0 MHz, 0.5 MHz, 0 MHz (no output) or 1.0 MHz, then the output signal (SIF2) of the second mixer 112 has a constant frequency component of 6.5 MHz. The relationship between these frequencies is shown in Table 1, which is similar to that described in Embodiment 1 with reference to Table 1.

The output signal of the second mixer 112 is supplied to the buffer amplifier 113 and then outputted from the SIF conversion circuit 1000. The output signal of the SIF conversion circuit 1000 is supplied to the band pass filter 9 at the rear stage which allows passage of a desired band, so that a second SIF signal having a single frequency is obtained.

In the case where an FM broadcast wave is received, by setting the frequency of the first SIF signal to, for example, 31.5 MHz, and setting the output of the frequency divider 117 to 1.0 MHz, the FM broadcast wave can be received. In this case, no video signal is supplied to the video intermediate frequency signal (VIF) processing section 4, and therefore the processing section 4 is in a halting state so as not to generate noises.

In this construction, the low pass filter 111 has a function of allowing passage of signals having a low frequency among the output signals of the first mixer 110. However, a band pass filter having such a frequency band can also be used. The buffer amplifier 113 is used to achieve impedance matching with the band pass filter 9 at the next stage, and generally also serves as an amplifier having an amplification degree.

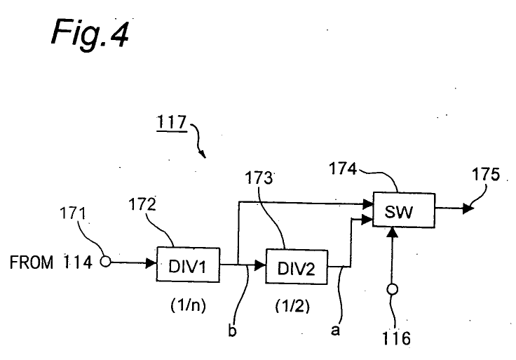

The circuit configuration and operation of the frequency divider 117 will now be described with reference to FIG. 4. FIG. 4 is a block diagram showing a configuration of the frequency divider 117 according to the present embodiment 2. The frequency divider 117 includes a first frequency divider (DIV1) 172 having a frequency dividing ratio of 1/n, a second frequency divider (DIV2) 173 having a frequency dividing ratio of 1/2, and a switch circuit (SW) 174. Reference numeral 171 denotes an input terminal for receiving the output signal of the oscillator 114. 175 denotes an output terminal, and 116 denotes a switching terminal for receiving a frequency dividing ratio selection signal.

The operation of the frequency divider 117 shown in FIG. 4 will now be described. The output signal from the oscillator 114 is supplied to the first frequency divider 172 via the input terminal 171. The frequency dividing ratio of the first frequency divider 172 is set so that the output frequency of the oscillator 114 is divided to 1.0 MHz. Then an output signal b is obtained by the first frequency divider 172. For example, if the oscillation frequency of the oscillator 114 is 26.0 MHz, the frequency dividing ratio is set to 1/26 to output the signal b of 1.0 MHz. Subsequently, the output signal b is supplied to the second frequency divider 173 having a frequency dividing ratio of 1/2, whereby a signal a having a divided frequency of 0.5 MHz is outputted from the second frequency divider 173. The output signal b (1.0 MHz) and the output signal a (0.5 MHz) are supplied to the switch circuit 174, and a signal of 0.5 MHz or 1.0 MHz is selected according to a control signal supplied from the terminal 116 for selecting the frequency dividing ratio, and the resultant signal of the selected frequency is outputted from the terminal 175.

It is noted here that, when the output frequency of the frequency divider 117 is 0 MHz (no output), it is considered that a signal having a frequency of 0 MHz is outputted from the terminal 175.

The use of the frequency divider 117 having the above described configuration makes it possible to construct an SIF conversion circuit of the present invention having a small number of elements. In this configuration, if a multiple number of 1.0 MHz is typically selected as the oscillation frequency of the oscillator 114, the configuration can be simplified.

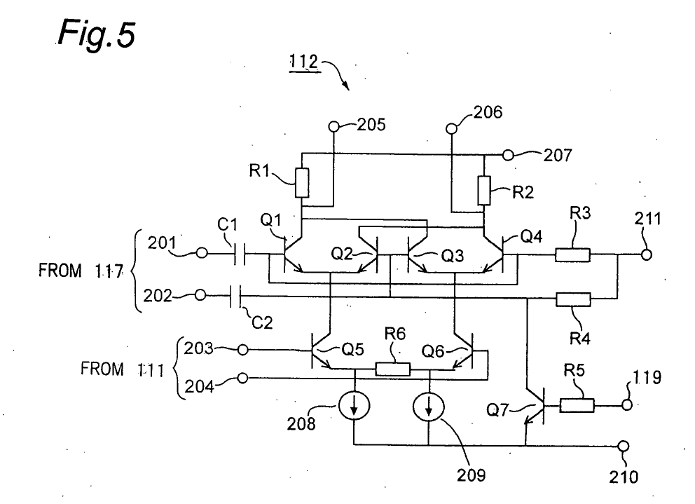

A detailed configuration and control operation of the second mixer (MIX2) 112 shown in FIG. 3 will now be described with reference to FIG. 5. Referring to FIG. 5, reference numeral R1 and R2 denote load resistances; R3, R4 and R5 denote base resistors; R6 denotes an emitter resistor; Q1 and Q2, Q3 and Q4, and Q5 and Q6 denote NPN transistors each pair of which constitutes a differential amplifier; Q7 denotes a switch transistor. R5 is a base resistance of Q7, and R5 and Q7 constitute a switch circuit. C1 and C2 denote coupling capacitors; 201 and 202 denote input terminals for receiving an oscillator output signal via the frequency divider 117; 203 and 204 denote input terminals for receiving an output signal of the low pass filter 111; 205 and 206 denote output terminals of the second mixer (MIX2) 112. 211 denotes a constant voltage terminal; 210 denotes a GND terminal; 207 denotes a power source terminal; 208 and 209 denote constant current sources; and 119 denotes a control terminal for stopping the operation of the mixer.

The operation of the second mixer (MIX2) 112 having the above described configuration will now be described. Referring to FIG. 5, the circuit constituted of the transistors Q1, Q2, Q3, Q4, Q5 and Q6, well known as a multiplexer, is used as an IC-incorporated mixer. An oscillator output is supplied to the terminals 201 and 202. The signal supplied to the terminals 203 and 204 is a pre-mixture signal which is not yet subjected to mixing processing. The supplied two signals are multiplied to output a signal from the output terminals 205 and 206, where the output signal has frequency components corresponding to a sum and a difference between the oscillator output and the output signal. In the present invention, the output of the frequency divider 117 is supplied to the terminals 201 and 202, and the output of the low pass filter 111 is supplied to the terminals 203 and 204, whereby the second SIF signal is outputted from the terminals 205 and 206.

Herein, the voltage of the constant voltage terminal 211 and the base resistances of R3 and R4 are set so that the transistors Q1, Q2, Q3 and Q4 are operable without saturation. The above described operation is obtained when the voltage of the terminal 119 is set so that the switch transistor Q7 is in the off state.

When the voltage of the terminal 119 is raised to turn on the transistor Q7, the base voltage of Q2 and Q3 is lowered approximately to the saturation voltage of Q7, so that Q1 and Q4 constituting the differential amplifier becomes a conduction state at all time. Accordingly, a signal supplied to the terminals 203 and 204 is outputted from the output terminals 205 and 206 without being multiplied by the output of the frequency divider supplied from the terminals 201 and 202.

Consequently, when the voltage of the terminal 119 is low, the circuit shown in FIG. 5 works as a mixer, and when the voltage of the terminal 119 is high, the circuit works only as a buffer amplifier.

By applying the second mixer 112 having the halting function by the terminal 119 to the present invention, a switchover of the output frequencies of the first mixer 110 and the second mixer 112 can be performed based on the control voltage supplied from the control terminal 119. That is, the output frequency is selected between the frequency obtained by the second mixer 112 performing the frequency conversion using the output of the frequency divider and the frequency obtained by the first mixer 110 without performing the frequency conversion by the second mixer 112. For example, referring to Table 1, when the frequency difference [(VIF)−(first SIF)] is 6.5 MHz, the output frequency of the second mixer 112 can be made to be equal to the output frequency of the first mixer 110 independently of the output of the frequency divider.

According to a preferable embodiment of the present invention, a crystal oscillator can be used as the oscillator 114 in the SIF conversion circuit. Thus, the oscillation signal to be supplied to the first mixer 110 and the second mixer 112 has a high Q value to be stable, thus having satisfactory noise characteristics. Accordingly, the outputted second SIF signal also has satisfactory noise characteristics, so that an SIF conversion circuit having a good sound S/N ratio can thus be provided.

According to another preferable embodiment of the present invention, in the SIF conversion circuit, the dividing operation of the frequency divider can be stopped when the second mixer 112 does not perform the frequency conversion operation. Accordingly, it is possible to eliminate a frequency dividing component and harmonic components thereof outputted from the frequency divider; and thus disturbance exerted by these components on the other blocks can be minimized.

According to another preferable embodiment of the present invention, by applying the SIF conversion circuit to a television receiver or an FM receiver, a receiver having a small size and excellent sound reception performance can be constructed. In the SIF conversion circuit according to the present invention, the output of a crystal oscillator and a frequency dividing output thereof are used to perform the frequency conversion, whereby a stable frequency conversion output having satisfactory noise characteristics can be obtained. Consequently, it is possible to construct a portable receiver, or a television receiver or an FM receiver most suitable for use in a mobile object such as a car, being under a particularly poor receiving condition.

As described above, the present invention is usefully applied to a television receiver or a sound receiver, such as an FM receiver, most suitable for use in a mobile object such as a car.

TABLE 1

| VIF − | 6.5 | MHz | 6.0 | MHz | 5.5 | MHz | 4.5 | MHz |
|---|---|---|---|---|---|---|---|---|
| FIRST | | | | | | | | |
| SIF | | | | | | | | |
| VIDEO | 38.0 | MHz | 38.0 | MHz | 38.0 | MHz | 38.0 | MHz |
| INTER- | | | | | | | | |
| MEDIATE | | | | | | | | |
| FREQUEN- | | | | | | | | |
| CY (VIF) | | | | | | | | |
| FIRST | 31.5 | MHz | 32.0 | MHz | 32.5 | MHz | 33.5 | MHz |
| SIF | | | | | | | | |
| OUTPUT | 5.5 | MHz | 6.0 | MHz | 6.5 | MHz | 7.5 | MHz |
| FREQUEN- | (57.5 | MHz) | (58.0 | MHz) | (58.5 | MHz) | (59.5 | MHz) |
| CY OF | | | | | | | | |
| MIXER | | | | | | | | |
| (MIX1) | | | | | | | | |
| OUTPUT | 1.0 | MHz | 0.5 | MHz | — | | 1.0 | MHz |
| FREQUEN- | | | | | | | | |
| CY OF | | | | | | | | |
| DIVIDER | | | | | | | | |
| OUTPUT | 6.5 | MHz | 6.5 | MHz | 6.5 | MHz | 6.5 | MHz |
| FREQUEN- | (4.5 | MHz) | (5.5 | MHz) | | | (8.5 | MHz) |
| CY OF | | | | | | | | |
| MIXER | | | | | | | | |
| (MIX2) | | | | | | | | |

What is clamed is:

1. A sound intermediate frequency conversion circuit which converts a frequency of a first sound intermediate frequency signal to obtain a second sound intermediate frequency signal having a constant frequency, the sound intermediate frequency conversion circuit comprising:
a first oscillator which outputs an oscillation signal;
a first mixer which receives the first sound intermediate frequency signal and the oscillation signal to be mixed with each other, and outputs a resultant mixed signal;
a filter which selectively passes a signal having a desired frequency among the output signals of the first mixer;
a second oscillator which outputs a reference oscillation signal;
a frequency divider which divides the frequency of the reference oscillation signal; and
a second mixer which mixes the output signal of the filter and the output signal of the frequency divider, and outputs the second sound intermediate frequency signal.

2. The sound intermediate frequency conversion circuit according to claim 1, wherein a reference signal oscillator of a tuner section generating the first sound intermediate frequency signal is used as the second oscillator.

3. A sound intermediate frequency conversion circuit which converts a frequency of a first sound intermediate frequency signal to obtain a second sound intermediate frequency signal having a constant frequency, the sound intermediate frequency conversion circuit comprising:
a reference signal oscillator which generates a reference oscillation signal;
a first mixer which receives the first sound intermediate frequency signal and the reference oscillation signal to be mixed with each other, and outputs a resultant mixed signal;
a filter which selectively passes a signal having a desired frequency among the output signals of the first mixer;
a frequency divider which divides the frequency of the reference oscillation signal; and
a second mixer which mixes the output signal of the filter and the output signal of the frequency divider, and outputs the second sound intermediate frequency signal.

4. The sound intermediate frequency conversion circuit according to claim 1, wherein the frequency divider includes a switching means for dividing the frequency of the reference oscillation signal and selecting a desired frequency as a frequency of the output signal of the frequency divider according to the frequency of the first sound intermediate frequency signal.

5. The sound intermediate frequency conversion circuit according to claim 3, wherein the frequency divider includes a switching means for dividing the frequency of the reference oscillation signal and selecting a desired frequency as a frequency of the output signal of the frequency divider according to the frequency of the first sound intermediate frequency signal.

6. The sound intermediate frequency conversion circuit according to claim 3, wherein the reference signal oscillator is a crystal oscillator.

7. The sound intermediate frequency conversion circuit according to claim 3, wherein the frequency divider stops the operation thereof when the second mixer does not perform a frequency conversion operation.

8. A sound receiver including a sound intermediate frequency conversion circuit which converts a frequency of a first sound intermediate frequency signal to obtain a second sound intermediate frequency signal having a constant frequency, the sound receiver comprising:
an antenna which receives an RF signal;
a tuner section which receives the RF signal, and converts the RF signal to the first sound intermediate frequency signal to be outputted therefrom;
a first filter which selectively passes the first sound intermediate frequency signal; and
a sound intermediate frequency processing section which outputs a sound baseband signal based on the second sound intermediate frequency signal,
wherein the sound intermediate frequency conversion circuit comprises:
a first oscillator which outputs an oscillation signal;
a first mixer which receives the first sound intermediate frequency signal and the oscillation signal to be mixed with each other, and outputs a resultant mixed signal;
a second filter which selectively passes a signal having a desired frequency among the output signals of the first mixer;
a second oscillator which outputs a reference oscillation signal;
a frequency divider which divides the frequency of the reference oscillation signal; and
a second mixer which mixes the output signal of the second filter and the output signal of the frequency divider, and outputs the second sound intermediate frequency signal.

9. A sound receiver including a sound intermediate frequency conversion circuit which converts a frequency of a first sound intermediate frequency signal to obtain a second sound intermediate frequency signal having a constant frequency, the sound receiver comprising:
an antenna which receives an RF signal;
a tuner section which receives the RF signal, and converts the RF signal to the first sound intermediate frequency signal to be outputted therefrom;
a first filter which selectively passes the first sound intermediate frequency signal; and
a sound intermediate frequency processing section which outputs a sound baseband signal based on the second sound intermediate frequency signal,
wherein the sound intermediate frequency conversion circuit comprises:
a reference signal oscillator which generates a reference oscillation signal;
a first mixer which receives the first sound intermediate frequency signal and the reference oscillation signal to be mixed with each other, and outputs a resultant mixed signal;
a second filter which selectively passes a signal having a desired frequency among the output signals of the first mixer;
a frequency divider which divides the frequency of the reference oscillation signal; and
a second mixer which mixes the output signal of the second filter and the output signal of the frequency divider, and outputs the second sound intermediate frequency signal.
